(19) United States
(12) Patent Application Publication
(10) Pub. No.: US 2019/0095059 A1
(43) Pub. Date: Mar. 28, 2019

(54) METHOD AND DEVICE FOR PROCESSING APPLICATION ICON AND ELECTRONIC APPARATUS

(71) Applicant: BEIJING KINGSOFT INTERNET SECURITY SOFTWARE CO., LTD., Beijing (CN)

(72) Inventor: Xiaobao Wang, Beijing (CN)

(73) Assignee: BEIJING KINGSOFT INTERNET SECURITY SOFTWARE CO., LTD., Beijing (CN)

(21) Appl. No.: 16/179,454

(22) Filed: Nov. 2, 2018

Related U.S. Application Data
(63) Continuation of application No. PCT/CN2017/071955, filed on Jan. 20, 2017.

(30) Foreign Application Priority Data
May 23, 2016 (CN) 201610346063.1

(51) Int. Cl. G06F 3/0482; G06F 3/0481; G06F 3/0486

(52) U.S. Cl. CPC G06F 3/0482; G06F 2203/04808; G06F 3/0486; G06F 3/04817

(57) ABSTRACT

A method and device for processing an application icon and an electronic device are provided. The method for processing an application icon includes: displaying an application icon management interface, the application icon management interface including multiple created desktop screens and a desktop screen creation control element; receiving information associated with operation of the desktop screen creation control element, and creating a target desktop screen, the target desktop screen being arranged following the last desktop screen displayed on the application icon management interface; and copying an icon shortcut associated with a target application to the target desktop screen.

### CROSS-REFERENCE TO RELATED APPLICATION

This application is a continuation application of International Application No. PCT/CN2017/071955, filed with the State Intellectual Property Office of P. R. China on Jan. 20, 2017, which claims priority to Chinese Patent Application No. 201610346063.1, filed on May 23, 2016, the entire content of which is incorporated herein by reference.

### FIELD

The present disclosure relates to information management technology, and in particular, to a method and a device for processing an application icon, and an electronic device.

### BACKGROUND

With continuous development of computer communication and Internet technology, electronic devices, such as smart mobile phones, personal digital assistants, handheld computers, and notebook computers, are becoming more and more widely used. The Internet information that electronic devices can accommodate grows exponentially, and the number of applications (APP) used to carry Internet information is also increasing, which greatly satisfies individual needs of different users.

In order to facilitate the management and operation of an application, when the user installs an application, the installed application icon is displayed on the desktop screen by creating a desktop shortcut, so that the user can launch the application by operating the application icon, thereby reducing the time required to launch the application.

Due to the large number of application icons, the desktop screen may not accommodate such a large number of application icons. Therefore, when application icons in the desktop screen exceed the arrangement number of the desktop screen, one or more desktop screens need to be created to perform effective management of the application icons. For example, in order to improve the search and use efficiency of the application, it is often necessary to perform some administrative operations on the desktop screen of the electronic device. In the related art, since the desktop screen creation widget is set in the newly created desktop screen, when creating a desktop screen, the desktop needs to be swiped until reaching the newly created desktop screen. Then, by clicking the widget of the newly created desktop screen, a created desktop screen is triggered to be the current desktop screen. Then, an icon shortcut associated with the application icon is copied or pasted to the current desktop screen in an application installation directory. However, this method for processing an application icon is cumbersome when creating a desktop screen, and the time required to construct the desktop screen is long, resulting in a low management efficiency of an application icon. For example, when the user has installed many applications, the electronic device is provided with nine desktop screens, namely a first desktop screen to a ninth desktop screen, with the first desktop screen being the current desktop screen. When the user needs to create a new tenth desktop screen, the user needs to continuously slide from the current desktop screen, slide from the first desktop screen to the second desktop screen, and then to the third desktop screen, so as to slide to the ninth desktop screen; then, click on a desktop screen creation widget on the ninth desktop screen to achieve the purpose of creating the new tenth desktop screen. Therefore, it takes a long time to slide desktop screens to the desktop screen with the desktop screen creation widget, thereby reducing the user's application experience.

### SUMMARY

For this purpose, a method and a device for processing an application icon, and an electronic device are provided by embodiments of the present disclosure, which may shorten the time required to create a desktop screen and improve the user's application experience in order to solve the problem that it takes a long time to slide desktop screens to the desktop screen with the desktop screen creation widget in methods for processing an application icon in the related art.

According to a first aspect of the present disclosure, there is provided a method for processing an application icon, including:

displaying an application icon management interface including a plurality of created desktop screens and a desktop screen creation widget;

receiving information associated with operation of the desktop screen creation widget, creating a target desktop screen arranged following a last desktop screen displayed on the application icon management interface;

copying an icon shortcut associated with a target application icon to the target desktop screen.

According to a second aspect of the present disclosure, there is provided a device for processing an application icon, including: a display module, a desktop screen building module, and an icon writing module.

The display module is configured to display an application icon management interface including a plurality of created desktop screens and a desktop screen creation widget.

The desktop screen building module is configured to receive information associated with operation of the desktop screen creation widget, and create a target desktop screen arranged following a last desktop screen displayed on the application icon management interface.

The icon writing module is configured to copy an icon shortcut associated with a target application icon to the target desktop screen.

According to a third aspect of the present disclosure, there is provided an electronic device including: a housing, a processor, a memory, a circuit board, and a power supply circuit, in which the circuit board is disposed inside a space enclosed by the housing, the processor and the memory are disposed on the circuit board; the power supply circuit is configured to power various circuits or elements of the electronic device; the memory is configured to store executable program code; and the processor is configured to execute a program corresponding to the executable program code by reading the executable program code stored in the memory, to perform a method for processing an application icon according to any one of the preceding methods.

According to a fourth aspect of the present disclosure, there is provided a storage medium storing one or more programs that, when executed by a device, cause the device to perform a method for processing an application icon according to any one of the preceding methods.

It is to be understood that both the foregoing general description and the following detailed description are exemplary and explanatory only and are not restrictive of the invention, as claimed.

### BRIEF DESCRIPTION OF THE DRAWINGS

In order to more clearly illustrate embodiments of the present disclosure or the technical solutions in the related art, the drawings used in the embodiments or the description of the related art will be briefly described below. Obviously, the drawings in the following description are only certain embodiments of the present disclosure, and other drawings can be obtained from these drawings by persons of ordinary skill in the art without any inventive effort.

FIG. 1 is a schematic flowchart showing a method for processing an application icon according to Embodiment 1 of the present disclosure;

FIG. 2 is a schematic diagram showing an application icon management interface according to the present embodiment;

FIG. 3 is a schematic block diagram showing a device for processing an application icon according to Embodiment 2 of the present disclosure;

FIG. 4 is a schematic block diagram showing an electronic device according to an embodiment of the present disclosure.

### DETAILED DESCRIPTION

Embodiments of the present disclosure will be described in detail with reference to drawings.

It should be understood that the described embodiments are only a part of, not all of, the embodiments of the present disclosure. All other embodiments obtained by persons of ordinary skill in the art based on the embodiments of the present disclosure without any inventive effort shall fall within protection scope of the present disclosure.

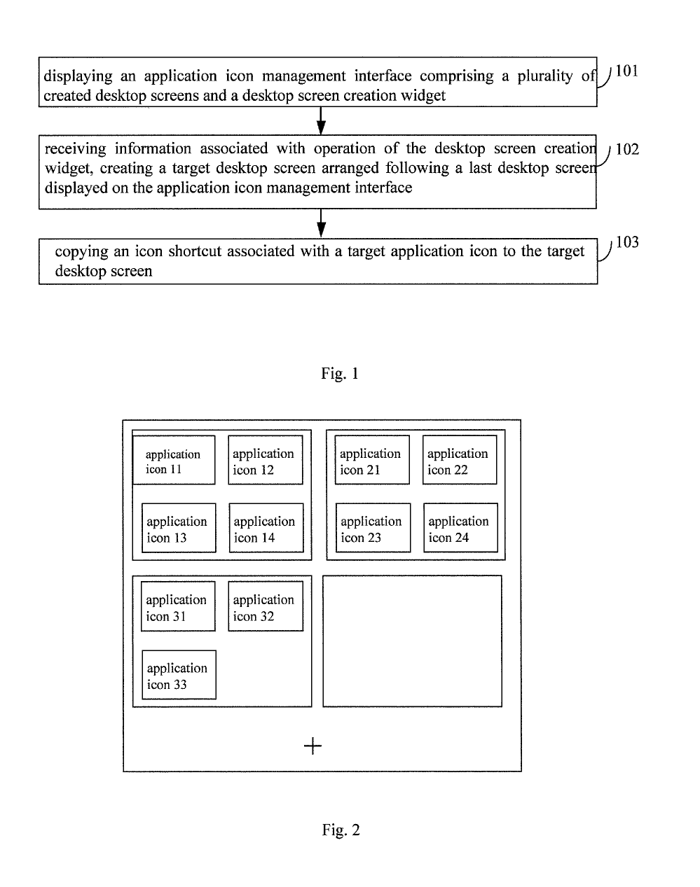

FIG. 1 is a schematic flowchart showing a method for processing an application icon according to Embodiment 1 of the present disclosure. As shown in FIG. 1, a method according to the present embodiment may include following steps 101 to 103.

At step 101, an application icon management interface is displayed comprising a plurality of created desktop screens and a desktop screen creation widget.

In the present embodiment, the application icon management interface is set with regard to available desktop screens integrating application icon applications with the application icon management to effectively manage the application icons.

In the present embodiment, the application icon management interface may be displayed after that an application icon management instruction is received.

As an optional embodiment, displaying the application icon management interface includes A11 and A12.

At A11, timing is started after detecting a pressing operation on a position of a non-application icon in a current application icon application interface.

In the present embodiment, as an optional embodiment, an operation instruction for triggering a switching to the application icon management interface in the current application icon application interface may be preset. For example, it may be set to trigger the switching to the application icon management interface when the user taps the blank area on a screen for 2 seconds or more.

At A12, When the timing exceeds a preset switching time threshold, it is confirmed that an application icon management instruction is received and the application icon management interface is switched to.

In the present embodiment, as described above, the switching time threshold is set to be 2 seconds.

As another optional embodiment, displaying the application icon management interface includes:

receiving an operational instruction of a switching management widget in the application icon application interface, and switching to the application icon management interface.

In the present embodiment, switching to the application icon management interface may be achieved by an operation instruction of clicking or double clicking the switching management widget.

Of course, in the actual application, other means may be used to switch to the application icon management interface, which is not limited in the present embodiment.

In the present embodiment, as an optional embodiment, one or more application icons are displayed on a created desktop screen.

In the present embodiment, as an optional embodiment, FIG. 2 is a schematic diagram of an application icon management interface according to the present embodiment. Referring to FIG. 2, the application icon management interface is divided into an upper part and a lower part, and the upper part is a desktop screen region, where one or more desktop screens are arranged according to a preset arrangement, and each desktop screen includes one or more application icons. The lower part is a desktop screen creation widget (mapped as a “+”). By clicking the desktop screen creation widget, a new desktop screen may be created following a last desktop screen arranged on the upper part.

In the present embodiment, as an optional embodiment, before displaying the application icon management interface, the method may further include:

obtaining a wallpaper corresponding to the current application icon application interface, and calculating a color average of the wallpaper as a color value of the application icon management interface.

In the present embodiment, the color average of the wallpaper is obtained by obtaining the wallpaper corresponding to the current application icon application interface (corresponding to a desktop screen), extracting a color value of each pixel point in the wallpaper, for example, RGB value, accumulating the extracted color values, and then dividing the accumulated color value by the number of pixel points. The color average of the wallpaper is the color value of the application icon management interface to be switched to, so that the color of the application icon management interface can be dynamically changed according to the wallpaper. The three-dimensionality of the interface is enhanced, giving the user a better visual experience.

At step 102, information associated with operation of the desktop screen creation widget is received, a target desktop screen arranged is created following a last desktop screen displayed on the application icon management interface.

In the present embodiment, a blank target desktop screen is created in the desktop screen region by an operation instruction of clicking or double clicking the desktop screen creation widget.

In the present embodiment, as an optional embodiment, the method may further include:

setting a wallpaper for the target desktop screen.

In the present embodiment, different desktop screens may be set with different wallpapers, or may be set with the same wallpaper.

At step 103, an icon shortcut associated with a target application icon is copied to the target desktop screen.

In the present embodiment, the icon shortcut associated with the target application icon may be copied to the current desktop screen from the installation directory corresponding to the target application icon; or the icon shortcut associated with the target application icon may be dragged to the current desktop screen from the installation directory corresponding to the target application icon. The number of the target application icons can be one or more.

In the present embodiment, in order to enhance the display contrast of the application icon in the desktop screen, the color of the application icon may be set to be a contrast color against a color of the surrounding desktop screen area, and thus, as an optional embodiment, after copying the icon shortcut associated with the target application icon to the target desktop screen, the method further includes B11, B12 and B13.

At B11, a color average of pixel points of the target desktop screen within a predetermined range is obtained with the target application icon as a center.

In the present embodiment, for example, the target application icon occupies 16 pixel points, the predetermined range is centered on the center of the 16 pixel points, and the number of pixel points in the predetermined range is set to be greater than or equal to 16.

In the present embodiment, as an optional embodiment, the color value is a three primary color value, including: a red color pixel value (R value), a green color pixel value (G value), and a blue color pixel value (B value).

In the present embodiment, the color average is an average of the red color pixel average, the green color pixel average, and the blue color pixel average.

At B12, a mapping relationship between a preset color value and a contrast color value is queried, and a contrast color value mapped by the color average is obtained.

At B13, the color value of the target application icon copied to the target desktop screen is set to be the obtained contrast color value.

In the present embodiment, the color value of the target application icon is set to be the contrast color value of the desktop screen where the target application icon is located, so that the application icon can be more easily recognized by the user, and the color value of the target application icon may vary along with the position of the target application icon, thus enhancing the user's visual experience.

In the present embodiment, as an optional embodiment, the method further includes:

dragging a first application icon in a first desktop screen;

detecting a stop position of the first application icon in a second desktop screen, and arranging the first application icon between two application icons when the stop position is between the two application icons; or exchanging the first application icon with a second application icon when the stop position coincides with a position of the second application icon.

In the present embodiment, as an optional embodiment, the first desktop screen and the second desktop screen may be a same desktop screen, or may be different desktop screens. Therefore, by displaying a plurality of desktop screens in the interface, the application icons can be easily and quickly adjusted and sorted. At the same time, the adjustment and sorting of the desktop screens in the application icon management interface can be implemented by the same method as that of the application icons.

Of course, other methods can also be used to implement mutual location exchange between two desktop screens or application icons. As another optional embodiment, the method further includes:

simultaneously detecting a first pressing operation on a first application icon and a second pressing operation on a second application icon;

exchanging a position of the first application icon with a position of the second application icon after detecting that the first pressing operation and the second pressing operation are simultaneously released.

As still another optional embodiment, the method further includes:

displaying a preset desktop screen deletion widget when no application icon is arranged on the desktop screen in the application icon management interface.

In the present embodiment, the deletion operation can be performed on the blank desktop screen only when no application icon is included in the desktop screen, which can effectively prevent the desktop screen with one or more application icons from being deleted by mistake.

As still another optional embodiment, the method further includes:

blanking the desktop screen deletion widget when an application icon is newly arranged in a blank desktop screen displaying the desktop screen deletion widget in the application icon management interface.

As still another optional embodiment, the method further includes:

switching to an application icon application interface corresponding to the application icon management instruction when receiving the application icon application instruction in the application icon management interface.

In the present embodiment, when the user presses a back key or a home key, it is confirmed that the application icon application instruction is received, and the application icon management interface is exited, and the application icon application interface before the switching is returned to.

As still another optional embodiment, the method further includes:

detecting an operation of the user in the application icon management interface, querying a mapping relationship between the operation of the user and an application function, and performing an execution function mapped with the detected operation of the user.

In the present embodiment, for example, when the user double-clicks the non-application icon location of a desktop screen in the desktop screen region, a switching to the application icon application interface corresponding to the desktop screen is triggered. For another example, when the user double-clicks an application icon of a desktop screen in the desktop screen region, an application corresponding to the application icon is triggered, and the application interface is entered.

As still another optional embodiment, the method further includes:

counting the number of times a user launches each application, and updating the application icons in a preset main desktop screen in descending order of the number of times.

In the present embodiment, by placing application icons that the user frequently launches on the main desktop screen set by the user, the user can directly enter the application icon application interface of the main desktop screen after turning on the electronic device, thereby facilitating operation of frequently used applications.

In the present embodiment, as an optional embodiment, an application icon that is not launched beyond a predetermined time threshold may be automatically deleted from the corresponding desktop screen.

The method for processing an application icon according to the Embodiment 1 in the present disclosure includes: displaying an application icon management interface comprising a plurality of created desktop screens and a desktop screen creation widget; receiving information associated with operation of the desktop screen creation widget, creating a target desktop screen arranged following a last desktop screen displayed on the application icon management interface; copying an icon shortcut associated with a target application icon to the target desktop screen. In this way, by setting the application icon management interface, a size of the desktop screen space is changed, and the limitation that a desktop screen can only be distributed in one screen in the related art is broken. A plurality of desktop screens is arranged in the set application icon management interface. The desktop screen creation widget in the application icon management interface can be operated to create a desktop screen without sliding a plurality of desktop screens. It may shorten the time required to create a desktop screen and improve the user's application experience. Furthermore, the color average of pixel points of the wallpaper is calculated as the color value of the application icon management interface, so that the color of the application icon management interface can be dynamically changed according to the wallpaper, giving the user a complete unified visual experience. Due to more desktop screens displayed in the same space, the operation cost of application icons or desktop screens can be reduced effectively.

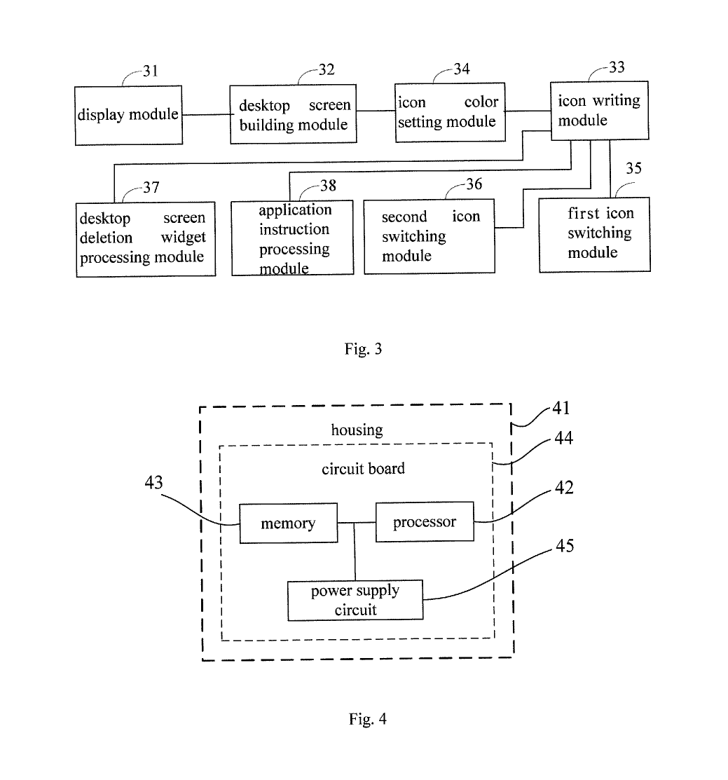

FIG. 3 is a schematic block diagram showing a device for processing an application icon according to Embodiment 2 of the present disclosure. As shown in FIG. 3, the device according to the present embodiment may include: a display module 31, a desktop screen building module 32, and an icon writing module 33.

The display module 31 is configured to display an application icon management interface comprising a plurality of created desktop screens and a desktop screen creation widget.

In the present embodiment, as an optional embodiment, one or more application icons are displayed in the created desktop screen.

In the present embodiment, as an optional embodiment, the display module 31 includes: a detecting unit and a switching unit (not shown).

The detecting unit is configured to start timing after detecting a pressing operation on a position of a non-application icon in a current application icon application interface.

The switching unit is configured to confirm that an application icon management instruction is received, and switch to the application icon management interface comprising the plurality of created desktop screens and the desktop screen creation widget when the timing exceeds a preset switching time threshold.

In the present embodiment, the application icon management interface is divided into an upper part and a lower part, and the upper part is a desktop screen region, where one or more desktop screens are arranged according to a preset arrangement, and each desktop screen includes one or more application icons. The lower part is a desktop screen creation widget (mapped as a “+”). By clicking the desktop screen creation widget, a new desktop screen may be created following a last desktop screen arranged on the upper part.

In the present embodiment, as an optional embodiment, the display module 31 further includes:

an application icon management interface color setting unit, configured to obtain a wallpaper corresponding to the current application icon application interface, and calculate a color average of the wallpaper as a color value of the application icon management interface.

The desktop screen building module 32 is configured to receive information associated with operation of the desktop screen creation widget, and create a target desktop screen arranged following a last desktop screen displayed on the application icon management interface.

In the present embodiment, the desktop screen building module is further configured to set a wallpaper for the target desktop screen.

In the present embodiment, different desktop screens may be set with different wallpapers, or may be set with the same wallpaper.

The icon writing module 33 is configured to copy an icon shortcut associated with a target application icon to the target desktop screen.

In the present embodiment, the icon shortcut associated with the target application icon may be copied to the current desktop screen from the installation directory corresponding to the target application icon; or the icon shortcut associated with the target application icon may be dragged to the current desktop screen from the installation directory corresponding to the target application icon.

In the present embodiment, as an optional embodiment, the device further includes:

an icon color setting module 34, configured to obtain a color average of pixel points of the target desktop screen within a predetermined range with the target application icon as a center; query a mapping relationship between a preset color value and a contrast color value, and obtain a contrast color value mapped by the color average; set the color value of the target application icon copied to the target desktop screen to be the obtained contrast color value.

In the present embodiment, the color average is an average of the red color pixel average, the green color pixel average, and the blue color pixel average.

In the present embodiment, as an optional embodiment, the icon color setting module 34 includes: a color average obtaining unit, a contrast color query unit, and an icon color setting unit (not shown).

The color average obtaining unit is configured to obtain a color average of pixel points of the target desktop screen within a predetermined range with the target application icon as a center.

The contrast color query unit is configured to query a mapping relationship between a preset color value and a contrast color value, and obtain a contrast color value mapped by the color average.

The icon color setting unit is configured to set the color value of the target application icon copied to the target desktop screen to be the obtained contrast color value.

In the present embodiment, as an optional embodiment, the device further includes:

a first icon switching module 35, configured to drag a first application icon in a first desktop screen; detect a stop position of the first application icon in a second desktop screen, and arrange the first application icon between two application icons when the stop position is between the two application icons; or exchange the first application icon with a second application icon when the stop position coincides with a position of the second application icon.

In the present embodiment, as an optional embodiment, the first desktop screen and the second desktop screen may be a same desktop screen, or may be different desktop screens.

In the present embodiment, as another optional embodiment, the device further includes:

a second icon switching module 36, configured to simultaneously detect a first pressing operation on a first application icon and a second pressing operation on a second application icon; and exchange a position of the first application icon with a position of the second application icon after detecting that the first pressing operation and the second pressing operation are simultaneously released.

In the present embodiment, as another optional embodiment, the device further includes:

a desktop screen deletion widget processing module 37, configured to display a preset desktop screen deletion widget when no application icon is arranged on the desktop screen in the application icon management interface; or

blank the desktop screen deletion widget when an application icon is newly arranged in a blank desktop screen displaying the desktop screen deletion widget in the application icon management interface.

In the present embodiment, the deletion operation can be performed on the blank desktop screen only when no application icon is included in the desktop screen, which can effectively prevent the desktop screen with one or more application icons from being deleted by mistake.

In the present embodiment, as another optional embodiment, the device further includes:

an application instruction processing module 38, configured to switch to an application icon application interface corresponding to the application icon management instruction when receiving the application icon application instruction in the application icon management interface.

In the present embodiment, when the user presses a back key or a home key, it is confirmed that the application icon application instruction is received, and the application icon management interface is exited, and the application icon application interface before the switching is returned to.

In the present embodiment, as another optional embodiment, the device further includes:

an icon adjustment module (not shown in figures), configured to count the number of times a user launches each application, and update the application icons in a preset main desktop screen in descending order of the number of times.

In the present embodiment, as another optional embodiment, the device further includes:

an application function detecting module (not shown in figures), configured to detect an operation of the user in the application icon management interface, query a mapping relationship between the operation of the user and an application function, and perform an execution function mapped with the detected operation of the user.

The device according to the present embodiment may be used to implement the technical solution of the method embodiment shown in FIG. 1 and FIG. 2, and the implementation principle and the technical effect thereof are similar, and details are not described herein again.

It should be noted that, in the present context, relational terms such as first and second, etc. are used merely to distinguish one entity or operation from another entity or operation, and do not necessarily require or imply that there is any such actual relationship or order between these entities or operations. Furthermore, the term “include”, “comprise” or any other variants thereof is intended to encompass a non-exclusive inclusion, such that a process, method, article, or device that comprises a plurality of elements includes not only those elements but also other elements that are not explicitly listed, or elements that are inherent to such a process, method, item, or device. An element that is defined by the phrase “comprising a . . . ” does not exclude the presence of additional equivalent elements in the process, method, item, or device that comprises the element, unless otherwise indicated.

The various embodiments in the present specification are described in a related manner, and the same or similar parts between the various embodiments may be referred to each other, and each embodiment focuses on the differences from the other embodiments.

In particular, for the device embodiment, since it is basically similar to the method embodiment, the description is relatively simple, and the relevant parts can be referred to the description of the method embodiment.

The logic and/or step described in the flow chart or described herein in other manners, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device or equipment and executing the instruction), or to be used in combination with the instruction execution system, device or equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read-only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination.

In the above embodiments, a plurality of steps or methods may be realized by the software or firmware stored in the memory and executed by the appropriate instruction execution system. For example, if realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Embodiments of the present disclosure further provide an electronic device including the device described in any of the foregoing embodiments.

FIG. 4 is a schematic block diagram of an embodiment of an electronic device according to the present disclosure, which can implement the process of the embodiments shown in FIGS. 1 to 3 of the present disclosure. As shown in FIG. 4, the electronic device may include: a housing 41, a processor 42, a memory 43, a circuit board 44 and a power supply circuit 45. The circuit board 44 is disposed inside a space enclosed by the housing 41. The processor 42 and the memory 43 are disposed on the circuit board 44. The power supply circuit 45 is configured to supply power to each circuit or component of the above electronic device. The memory 43 is configured to store executable program code. The processor 42 is configured to execute a program corresponding to the executable program code by reading the executable program code stored in the memory 43 for performing any of the application icon processing method in foregoing embodiments.

The specific execution process of the above steps by the processor 42 and the steps further performed by the processor 42 by executing the executable program code can be referred to the description of embodiments shown in FIGS. 1 to 3 of the present disclosure, and the details are not described herein.

The electronic device exists in a variety of forms including, but not limited to mobile communication devices, ultra-mobile PC devices, portable entertainment devices, servers, and other electronic devices with data interaction capabilities as follows:

(1) Mobile communication devices: These devices are characterized by mobile communication functions and are mainly aimed at providing voice and data communication. Such terminals include: smart phones (such as iPhone), multimedia phones, functional phones, and low-end phones.

(2) Ultra-mobile PC devices: These devices belong to the category of personal computers, have computing and processing functions, and generally have mobile Internet access. Such terminals include: PDAs (personal digital assistants), MIDs, and UMPC devices, such as iPad.

(3) Portable entertainment devices: These devices can display and play multimedia contents. Such devices include: audio, video players (such as iPod), handheld game consoles, e-books, and smart toys and portable in-vehicle navigation devices.

(4) Servers: A device that provides computing services. The servers include processors, hard disks, memories, system buses, etc. The servers are similar to general-purpose computer architecture, but because of the need to provide highly reliable services, it is highly demanding in terms of processing power, stability, reliability, security, scalability, and manageability.

(5) Other electronic devices with data interaction capabilities.

One of ordinary skill in the art can understand that all or part of the steps carried by the method of implementing the above embodiments can be completed by a program to instruct related hardware, and the program can be stored in a computer readable storage medium. When executed, one or a combination of the steps of the method embodiments is included.

For the convenience of description, the above devices are described as being separately divided into various units/modules. Of course, the functions of the various units/modules may be implemented in one or more software and/or hardware in the practice of the present disclosure.

From the description of the above embodiments, it will be apparent to those skilled in the art that the present disclosure can be implemented by means of software plus a necessary general hardware platform. Based on such understanding, the technical solution of the present disclosure may be embodied in the form of a software product in essence or in the form of a software product, which may be stored in a storage medium such as a ROM/RAM, a magnetic disk or an optical disk or the like, comprising a number of instructions for causing a computer device (which may be a personal computer, a server, or a network device, etc.) to perform the methods described in various embodiments of the present disclosure or portions of the embodiments.

The above is only a specific embodiment of the present disclosure, but the scope of the present disclosure is not limited thereto, and any person skilled in the art can easily think of changes or substitutions within the technical scope of the present disclosure. All should be covered by the scope of the present disclosure. Therefore, the scope of the disclosure should be determined by the scope of the claims.

What is claimed is:

1. A method for processing an application icon, comprising:
displaying an application icon management interface comprising a plurality of created desktop screens and a desktop screen creation widget;
receiving information associated with operation of the desktop screen creation widget, creating a target desktop screen arranged following a last desktop screen displayed on the application icon management interface;
copying an icon shortcut associated with a target application icon to the target desktop screen.

2. The method according to claim 1, wherein displaying the application icon management interface comprises:
starting timing after detecting a pressing operation on a position of a non-application icon in a current application icon application interface;
confirming that an application icon management instruction is received, and switching to the application icon management interface when the timing exceeds a preset switching time threshold.

3. The method according to claim 1, wherein before displaying the application icon management interface, the method further comprises:
obtaining a wallpaper corresponding to the current application icon application interface, and calculating a color average of the wallpaper as a color value of the application icon management interface.

4. The method according to claim 1, wherein after copying the icon shortcut associated with the target application icon to the target desktop screen, the method further comprises:
obtaining a color average of pixel points of the target desktop screen within a predetermined range with the target application icon as a center;
querying a mapping relationship between a preset color value and a contrast color value, and obtaining a contrast color value mapped by the color average;
setting the color value of the target application icon copied to the target desktop screen to be the obtained contrast color value.

5. The method according to claim 1, further comprising:
dragging a first application icon in a first desktop screen;
detecting a stop position of the first application icon in a second desktop screen, and arranging the first application icon between two application icons when the stop position is between the two application icons; or exchanging the first application icon with a second application icon when the stop position coincides with a position of the second application icon.

6. The method according to claim 1, further comprising:
simultaneously detecting a first pressing operation on a first application icon and a second pressing operation on a second application icon;
exchanging a position of the first application icon with a position of the second application icon after detecting that the first pressing operation and the second pressing operation are simultaneously released.

7. The method according to claim 1, further comprising:
displaying a preset desktop screen deletion widget when no application icon is arranged on the desktop screen in the application icon management interface; or
blanking the desktop screen deletion widget when an application icon is newly arranged in a blank desktop screen displaying the desktop screen deletion widget in the application icon management interface.

8. The method according to claim 1, further comprising:
switching to an application icon application interface corresponding to the application icon management instruction when receiving an application icon application instruction in the application icon management interface.

9. The method according to claim 1, further comprising:
counting the number of times a user launches each application, and updating the application icons in a preset main desktop screen in descending order of the number of times.

10. An electronic device, comprising: a housing, a processor, a memory, a circuit board, and a power supply circuit, wherein the circuit board is disposed inside a space enclosed by the housing, the processor and the memory are disposed on the circuit board; the power supply circuit is configured to power various circuits or elements of the electronic device; the memory is configured to store executable program code; and the processor is configured to execute a program corresponding to the executable program code by reading the executable program code stored in the memory, to:
display an application icon management interface comprising a plurality of created desktop screens and a desktop screen creation widget;
receive information associated with operation of the desktop screen creation widget, create a target desktop screen arranged following a last desktop screen displayed on the application icon management interface;
copy an icon shortcut associated with a target application icon to the target desktop screen.

11. The device according to claim 10, wherein the processor is further configured to:
start timing after detecting a pressing operation on a position of a non-application icon in a current application icon application interface;
confirm that an application icon management instruction is received, and switch to the application icon management interface when the timing exceeds a preset switching time threshold.

12. The device according to claim 10, wherein the processor is further configured to:
obtain a wallpaper corresponding to the current application icon application interface, and calculate a color average of the wallpaper as a color value of the application icon management interface.

13. The device according to claim 10, wherein the processor is further configured to:
obtain a color average of pixel points of the target desktop screen within a predetermined range with the target application icon as a center;
query a mapping relationship between a preset color value and a contrast color value, and obtain a contrast color value mapped by the color average;
set the color value of the target application icon copied to the target desktop screen to be the obtained contrast color value.

14. The device according to claim 10, wherein the processor is further configured to:
drag a first application icon in a first desktop screen;
detect a stop position of the first application icon in a second desktop screen, and arrange the first application icon between two application icons when the stop position is between the two application icons; or exchange the first application icon with a second application icon when the stop position coincides with a position of the second application icon.

15. The device according to claim 10, wherein the processor is further configured to:
simultaneously detect a first pressing operation on a first application icon and a second pressing operation on a second application icon;
exchange a position of the first application icon with a position of the second application icon after detecting that the first pressing operation and the second pressing operation are simultaneously released.

16. The device according to claim 10, wherein the processor is further configured to:
display a preset desktop screen deletion widget when no application icon is arranged on the desktop screen in the application icon management interface; or
blank the desktop screen deletion widget when an application icon is newly arranged in a blank desktop screen displaying the desktop screen deletion widget in the application icon management interface.

17. The device according to claim 10, wherein the processor is further configured to:
switch to an application icon application interface corresponding to the application icon management instruction when receiving an application icon application instruction in the application icon management interface.

18. The device according to claim 10, wherein the processor is further configured to:
count the number of times a user launches each application, and update the application icons in a preset main desktop screen in descending order of the number of times.

19. A non-transitory computer-readable storage medium storing one or more programs that, when executed by a device, cause the device to perform a method for processing an application icon, the method comprising:
displaying an application icon management interface comprising a plurality of created desktop screens and a desktop screen creation widget;
receiving information associated with operation of the desktop screen creation widget, creating a target desktop screen arranged following a last desktop screen displayed on the application icon management interface;
copying an icon shortcut associated with a target application icon to the target desktop screen.
